(19) United States
(12) Patent Application Publication
(10) Pub. No.: US 2011/0035660 A1
(43) Pub. Date: Feb. 10, 2011

(54) SYSTEM AND METHOD FOR THE AUTOMATED CREATION OF A VIRTUAL PUBLICATION

(76) Inventors: Frederick Lussier, Montreal (CA); Carl Fugere, Lachenaie (CA)

Correspondence Address: POLSINELLI SHUGHART PC, 700 W. 47TH STREET, SUITE 1000, KANSAS CITY, MO, 64112-1802, US

(21) Appl. No.: 12/675,757

(22) PCT Filed: Sep. 2, 2008
(86) PCT No.: PCT/CA2008/001552

§ 371 Date: Oct. 27, 2010

Related U.S. Application Data
(60) Provisional application No. 60/935,810, filed on Aug. 31, 2007.

(51) Int. Cl. G06F 17/00; G06F 17/20; G06F 17/30; G06F 5/00

(52) U.S. Cl. 715/239; 715/234

(57) ABSTRACT

A method and system for creating a virtual publication for use with a flip page application, the virtual publication comprising an image file of each page of the virtual publication to be displayed by the flip page application, a SWF file of each page of the virtual publication to be used by the flip page application to provide a zoom functionality, a text file of each page of the virtual publication to be associated with each image file by the flip page application in order to provide a search functionality, an XML file of each page of the virtual publication indicating coordinates and links of multimedia elements to be used by the flip page application to provide clickable zones and an index file listing of all image and SWF files composing the virtual publication for indicating to the flip page application which files to use.

### CROSS-REFERENCE TO RELATED APPLICATION

The present application claims the benefits of U.S. provisional patent application No. 60/935,810 filed Aug. 31, 2007, which is hereby incorporated by reference.

### TECHNICAL FIELD

The present invention relates to system and method for the automated creation of a virtual publication.

### BACKGROUND

Newspapers, magazines, catalogs, trade journals and other documents are now commonly published in an electronic format on websites and are accessible via the Internet using a web browser.

A typical method of displaying electronic documents on a website is to represent the document as a continuous scroll with an associated scroll-bar for advancing the displayed representation. Most web browsers utilize this scroll metaphor for displaying electronic information. The display of electronic documents as a continuous scroll in the conventional manner, however, possesses a number of deficiencies in displaying certain types of documents. For example, users may have difficulty accessing and interacting with information when a conventional scroll is applied to a large document. Furthermore, many users prefer the “look and feel” of printed documents.

Accordingly, another metaphor for displaying electronic documents in the form of a three-dimensional book visual display was developed. The display of electronic documents as a three-dimensional book allows for browsing similar to that of a regular printed document combined with some interaction similar to the functionality of a web browser. However, there lacks a tool for automatically creating such displays from more conventional electronic document formats such as, for example, the PDF or WORD formats and publishing it on a website.

Accordingly, there is a need for a system and method for converting and editing content of an existing document in a first digital version into a second version that may be used by a three-dimensional book display application that includes much of the functionalities of a web browser.

### SUMMARY

The present invention relates to a method for creating a virtual publication for use with a flip page application, comprising:
acquiring an electronic document;
converting each page of the electronic document into an image file to be displayed by the flip page application;
converting each page of the electronic document into a SWF file to be used by the flip page application to provide a zoom functionality; and
creating an index file listing of all image and SWF files composing the virtual publication for indicating to the flip page application which files to use.

The present invention also relates to a system implementing the above described method.

The present invention further relates to a virtual publication for use with a flip page application, comprising:
an image file of each page of the virtual publication to be displayed by the flip page application;
a SWF file of each page of the virtual publication to be used by the flip page application to provide a zoom functionality; and
an index file listing of all image and SWF files composing the virtual publication for indicating to the flip page application which files to use.

### BRIEF DESCRIPTION OF THE FIGURES

Embodiments of the invention will be described by way of example only with reference to the accompanying drawings, in which:

FIG. 1 is a schematic view of computing devices connected to a virtual publication system through a network;

FIG. 2 is a flow diagram depicting the process of an administrator accessing virtual publication system;

FIG. 3 is a flow diagram depicting the automated virtual publication conversion process;

FIG. 4 is a schematic view of the automated virtual publication conversion process of FIG. 3 applied to a PDF document;

FIG. 5 is a detailed schematic view of FIG. 1;

FIG. 6 is a flow diagram depicting the virtual publication editor process;

FIG. 7 is an image of an exemplary virtual publication editor interface;

FIG. 8 is a flow diagram depicting the process of a user accessing a virtual publication; and

FIG. 9 is an image of an exemplary virtual publication interface.

### DETAILED DESCRIPTION

Generally stated, the non-limitative illustrative embodiment of the present invention provides a system and method for the automated conversion of a PDF publication into a virtual publication accessible through a network.

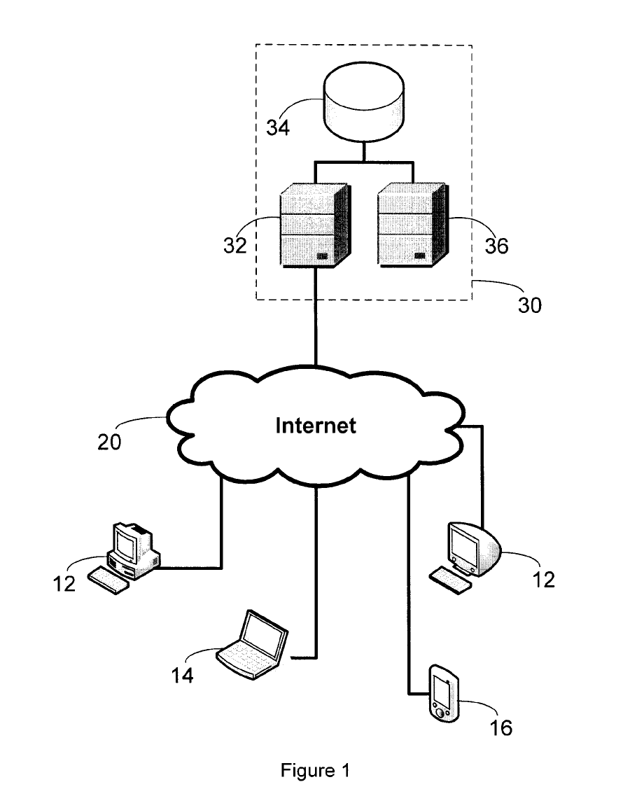

Referring to FIG. 1, a user using a personal computer 12, laptop computer 14 or personal assistant device 16, or any other such computing device, on which runs a user interface in the form of a communication software such as, for example, a web browser, may access the virtual publication system 30 through the access server 32 via an Internet connection 20 such as, for example, Ethernet (broadband, high-speed), wireless WiFi, cable Internet, satellite connection, cellular or satellite network, etc. Further to the access server 32, the virtual publication system 30 includes a content repository 34 and a conversion server 36, all of which will be detailed further below.

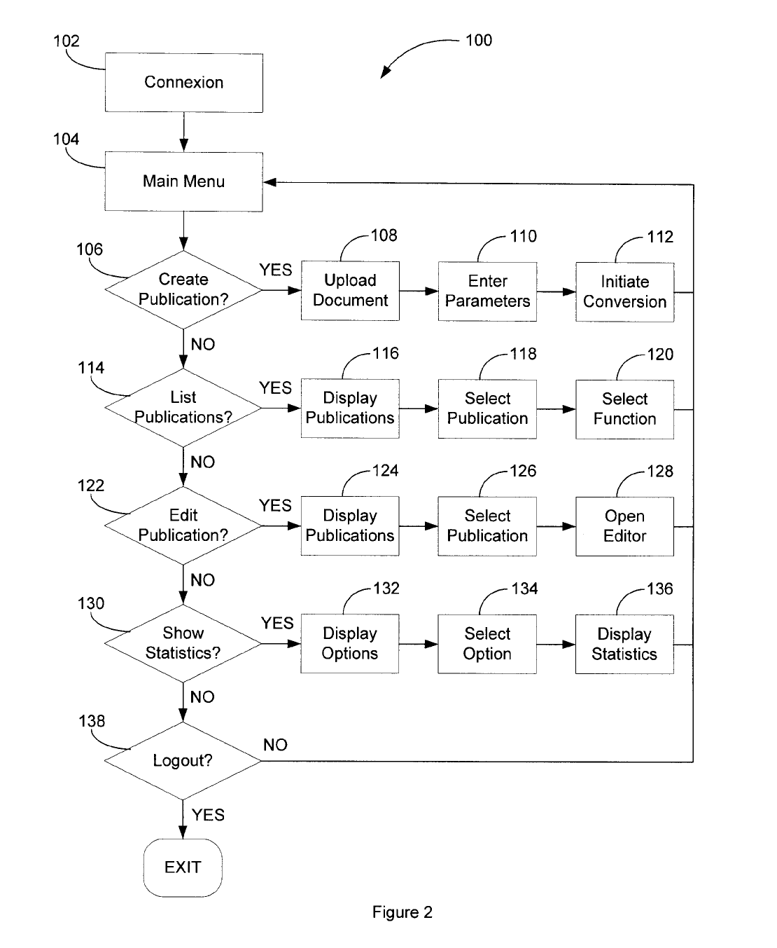

Referring now to FIG. 2, there is shown a flow diagram of an illustrative example of a process 100 executed by an administrator accessing the virtual publication system 30 in order to manage and produce virtual publications. The steps of the process 100 are indicated by blocks 102 to 138.

The process 100 starts at block 102 where the administrator connects to the virtual publication system 30. The connection may be effectuated using, for example, a secure connection with a login and password.

Then, at block 104, the administrator accesses the main menu where he or she may select various options, such as, for example, create a new virtual publication, list existing virtual publications, edit a virtual publication or show statistics. It is to be understood that other options may be added, for example user and system management options (i.e. create user, set permissions, etc.).

At block 106, the process verifies if the administrator has selected to create a new virtual publication. If so, at block 108, the administrator uploads the publication document in, for example, PDF format or selects it from a list of PDF documents already present on the conversion server 36. Then, at block 110, the administrator may enter publication parameters such as, for example:
the title of the new virtual publication which is to appear in the title bar of the browser;
the type of the new virtual publication, i.e. magazine, flyer, catalogue, etc. (the type may be used to tailor the look and layout of the virtual publication);
enter metadata that may be used in searches;
enter a password in order to restrict access to some functionalities with respect to this new virtual publication, i.e. edit, delete, etc.;
selection of one or more image quality and/or resolution (instead of the default value(s));
selection of cropping values or canvas;
image smoothing;
black and white or grayscale; and
ignore errors so that the automated conversion process is not interrupted.

At block 112, the process 100 initiates the automated conversion of the PDF document by launching the automated virtual publication creation process, which will be further detailed below. The process 100 then returns to block 104.

At block 114, the process 100 verifies if the administrator has selected to list existing virtual publications. If so, at block 116, the virtual publication system 30 displays all of the existing virtual publications stored in the content repository 34. Then, at block 118, administrator may select a virtual publication to which he or she may apply a desired function, which is selected at block 120, for example:
update the attributes of the selected virtual publication, i.e. title, type, topic, include/do not include in a search, page format, etc.;
delete the selected virtual publication;
edit the metadata of the selected virtual publication;
view statistics for the selected virtual publication;
view logs for the selected virtual publication; and
display linking code to the selected virtual publication, i.e. for example javascript code, to be included in a third party web page in order to provide access to or imbed the virtual publication.

It is to be understood that certain functions may be restricted to specific users or be password protected, for example the “delete” function.

The process 100 then returns to block 104.

At block 122, the process 100 verifies if the administrator has selected to edit a virtual publication. If so, at block 124, the virtual publication system 30 displays all of the existing virtual publications stored in the content repository 34. Then, at block 126, administrator selects a virtual publication to be edited and, at block 128, the virtual publication editor, which will be further detailed below, is opened. Once the editing is completed, the process 100 returns to block 104.

At block 130, the process 100 verifies if the administrator has selected to show statistics. If so, at block 132, the virtual publication system 30 displays a list of available statistics such as, for example, average time per visit, number of pages viewed by visit, number of hits by page or virtual publication, searched keywords, countries/cities of the viewer, zooms per pages, prints per pages, clicks per pages, etc. Furthermore, the various statistics may be selected by time units such as, for example, per hour, day, week, month, etc. It is to be understood that other statistics than those listed may be displayed and such are well known in the art. Then, at block 134, the administrator selects the desired option and, at block 136, the virtual publication system 30 displays the selected statistics. The process 100 then returns to block 104.

Finally, at block 138, the process 100 verifies if the administrator has selected to logout. If so, the process 100 exits, if not, it returns to block 104.

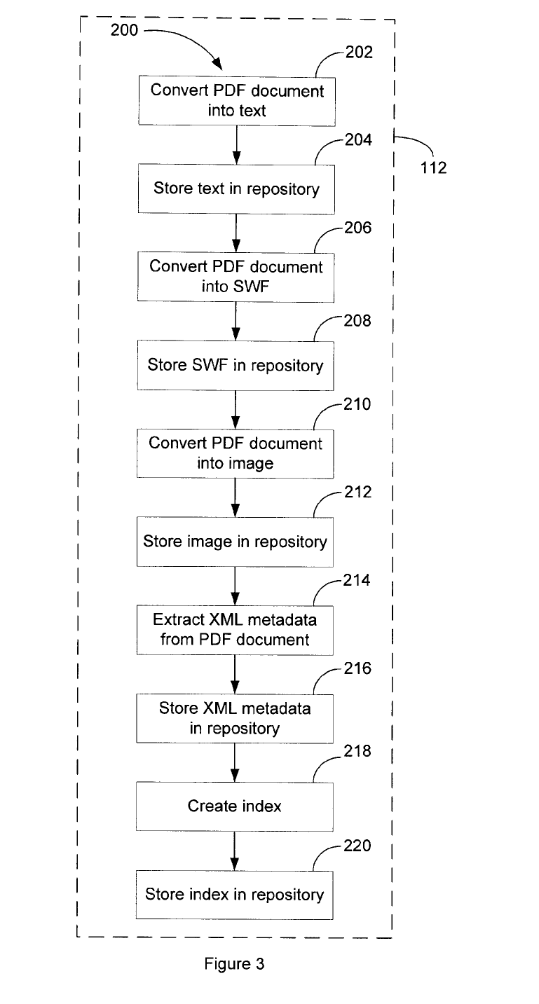

Referring to FIG. 3, there is shown a flow diagram of an illustrative example of an automated conversion process 200 executed by the virtual publication system 30, at block 112 of process 100 (see FIG. 2), in order to produce a new virtual publication from a PDF document. The steps of the process 200 are indicated by blocks 202 to 220 and may be executed, for example, by the conversion server 36.

The process 200 starts at block 202 where each page of the PDF document is converted into text using, for example, the TET software from PDFLIB and, at block 204, stores the resulting text into the content repository 34. The text version of the PDF document allows the full text search of the virtual publication.

Optionally, at block 202, the text is supplemented with HTML tags that are allocated based on, for example, the relative text size, resulting in <H1>, <H2>, <H3> or no tag. The purpose of the HTML tags is to facilitate the indexing and prioritization of text elements by the virtual publication search function as well as other search engines such as, for example, Google™.

Then, at block 206, each page of the PDF document is converted into Shockwave Flash™ format (SWF) using, for example, the PDF2SWF software from the SWFTOOLS open source family of software and, at block 208, stores the resulting SWF files into the content repository 34. The Flash™ version of the PDF document allows for a high resolution view of the virtual publication using the zoom function.

Following which, at block 210, each page of the PDF document is converted into an image (for example in the JPG format) using, for example, the PDF2IMAGE software from PDFTRON and, at block 212, stores the resulting images into the content repository 34. The image versions of the PDF document are used by the virtual publication application, further detailed below, used to view the virtual publication. Optionally, if required by the virtual publication application used to display the virtual publication, the virtual publication system 30 may produce images of different resolutions, for example four, in order to adjust to the most commonly used screen resolutions and to the bandwidth available to the user. Thumbnails may also be produced to be used in a table of content as well as in the display of search results. Alternatively, the image resolutions may be set at block 110 of process 100 shown in FIG. 2.

At block 214, metadata in XML format is extracted from each page of the PDF document using, for example, the PCOS software from PDFLIB and, at block 216, stores the resulting XML metadata into the content repository 34. The stored XML metadata takes the form of:
a table of content file that includes an index table, to be used by the navigation menu of the virtual publication, and an identifier as well as the dimensions of each page of the PDF document;
an individual file for each page of the PDF document, which includes, for example, the identification of “hotspots” or other linked elements (e.g. a video) with their coordinates and associated URL or other link to be used as clickable zones in the virtual publication; and
an editable configuration file that includes various appearance parameters such as, for example, background and text color schemes, margins, shadowing, etc.

Finally, at block 218, an index linking the text, SWF, image and XML metadata files is created and, at block 220, stored into the content repository 34. The index may take various forms providing a list of, or links to, all the components of each virtual publication, i.e. text, SWF, image(s) and XML files, to be loaded by the virtual publication application.

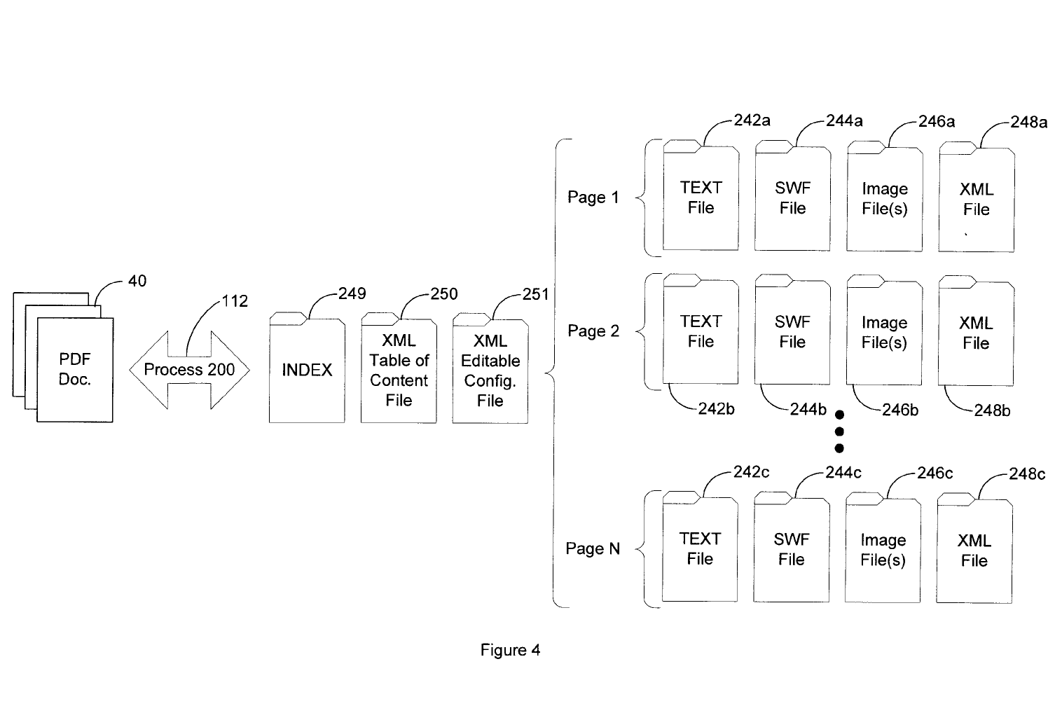

Referring to FIG. 4, the application of process 200, illustrated in FIG. 2, to a PDF document 40 results in the creation of an index file 249, an XML table of content file 250 and an XML editable configuration file 251, which describe the general structure of the virtual publication. Created as well, for each page of the PDF document 40, are a text file 242, a SWF file 244, one or more image file(s) 246 and an XML file 248, which describe the content and functionalities of each page of the virtual publication.

It is to be understood that the order of execution of blocks 202, 206, 210 and 214 is not limited to the that shown in FIG. 3 and that these steps may be executed in a different order or in parallel. It is also to be understood that the conversion and extraction software mentioned at blocks 202, 206, 210 and 214 are given for illustrative purpose only and that they may be replaced by equivalent software.

It is also to be understood that the automated conversion process 200 may be set so as to be automatically activated at specified intervals or may be activated automatically when a PDF document is uploaded, for example, in a specific repository.

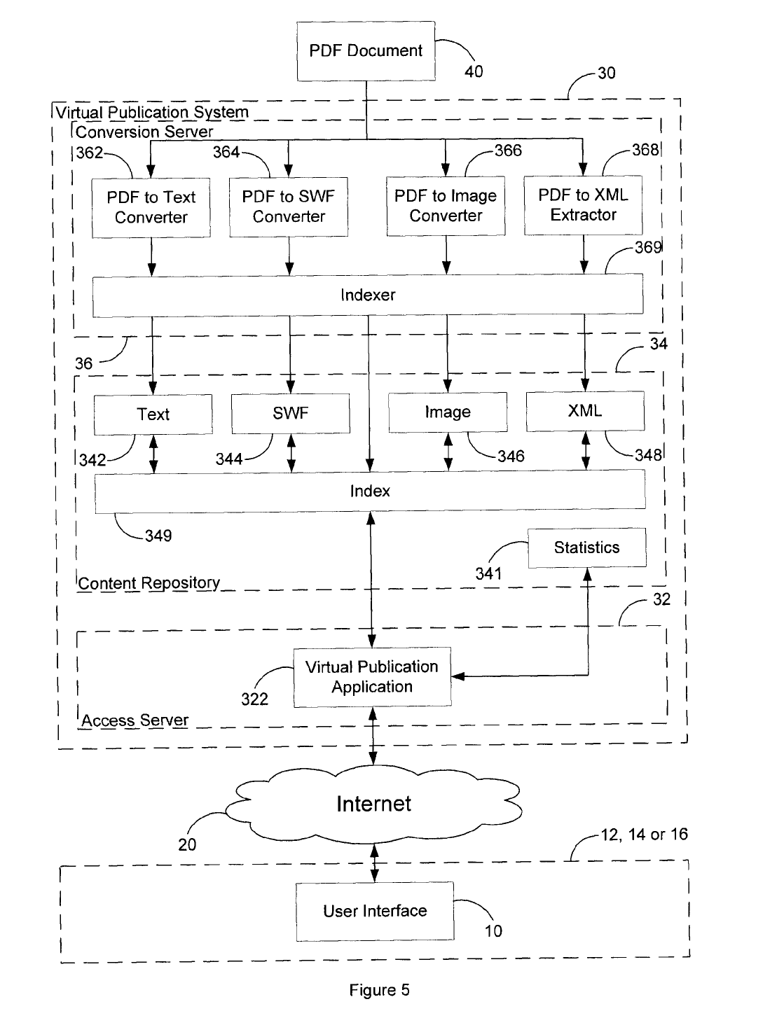

Referring now to FIG. 5, there is shown a detailed view of the components of FIG. 1 with regards to the above described processes 100, 200 shown in FIGS. 2 and 3, respectively.

As previously mentioned, the virtual publication system 30 includes an access server 32, a content repository 34 and a conversion server 36.

The conversion server 36 includes five main components: a PDF to text converter 362, a PDF to SWF converter 364, a PDF to image converter 366, a PDF to XML extractor 368 and an indexer 369 used by process 200 of FIG. 3 to process the PDF document 40, submitted to an input of the conversion server 36, at respective blocks 202, 206, 210, 214 and 218.

The content repository 34 includes six main components: a text repository 342, a SWF repository 344, an image repository 346, a XML repository 348 and an index repository 349 used by process 200 of FIG. 3 to store elements of the processed PDF document at respective blocks 204, 208, 212, 216 and 220, as well as a statistics repository 341 which will be further detailed below. Namely, with reference to FIG. 4, the text repository 342 contains the text files 242, the SWF repository 344 the SWF files 244, the image repository 346 the image files 246, the XML repository 348 the XML files 248, XML table of content files 250 and XML editable configuration files 251, and the index repository 349 the index file 249. It is to be understood that the various repositories 342, 344, 346, 348 and 349 may be combined in part or in whole, or further subdivided.

As for the access server 32, it includes a virtual publication application 322 which serves as an interface between a user using a user interface 10 running on a personal computer 12, laptop computer 14 or personal assistant device 16, or any other such computing device (see FIG. 1) and the virtual publication system 30.

It is to be understood that although throughout the disclosure reference is made to separate access 32 and conversion 36 servers as well as content repository 34, these may be implemented on one or more physical device and/or may be combined.

The virtual publication application 322 may be, for example, a flip page application for flipping through the pages of the virtual publication as if it was a physical document and may be implemented using, for example, Adobe Flash™

### Virtual Publication Editor

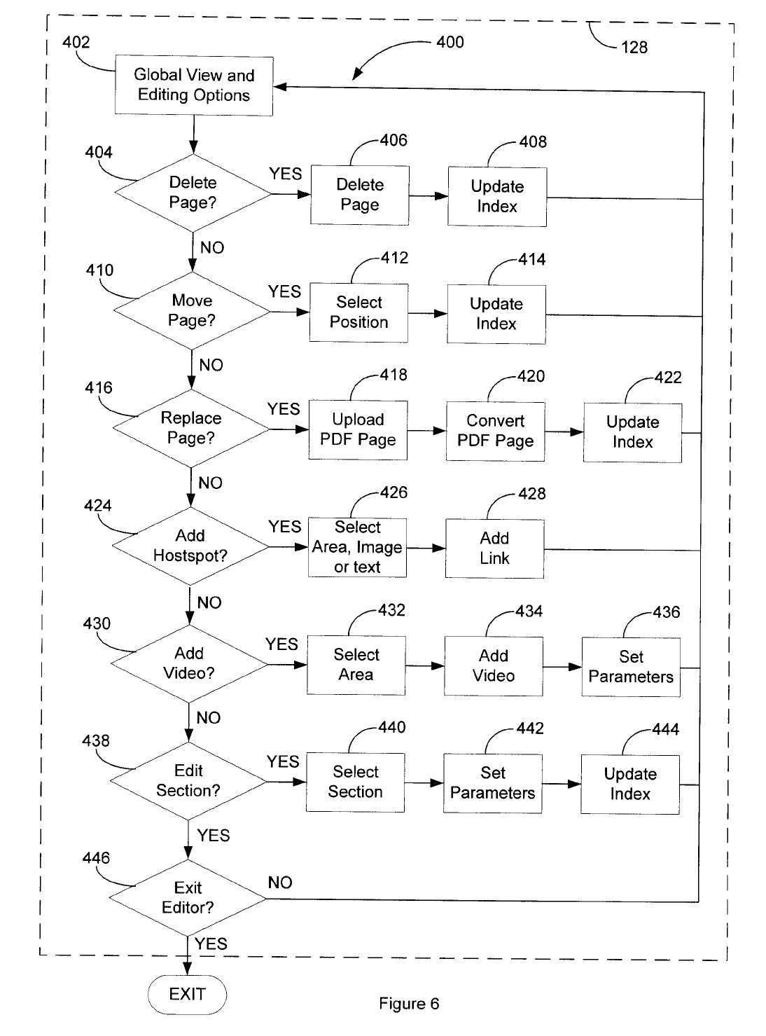

Referring to FIG. 6, there is shown a flow diagram of an illustrative example of a process 400 executed by the virtual publication editor, used at block 128 of FIG. 2. The steps of the process 400 are indicated by blocks 402 to 446.

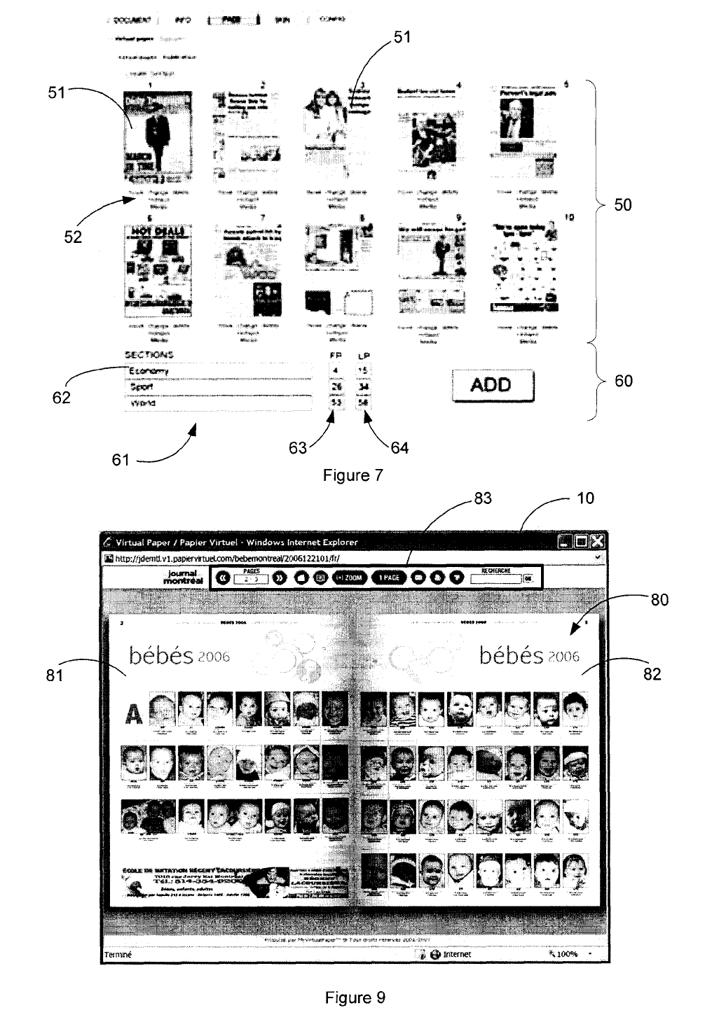

The process 400 starts at block 402 where a global view of the virtual publication is displayed, for example by displaying the thumbnails 51 of each of the pages of the virtual publication in a first zone and a list of sections 61 in a second zone 60, as shown in FIG. 7. For each page (i.e. thumbnail 51) in the first zone 50, the administrator is offered a list of functions 52 such as, for example, delete page, move page, replace page, add hotspot and add video. Furthermore, the administrator is given the opportunity to edit the sections 61 of the second zone 60.

At block 404, the process 400 verifies if the administrator has selected to delete a page. If so, at block 406, the page is deleted from the virtual publication, i.e. the associated text 242, SWF 244, image 246 and XML 248 files (see FIG. 4) are deleted. Then, at block 408, the index 249 and XML table of content 250 files (see FIG. 4) are updated in order to reflect the change, i.e. pages are renumbered, links are adjusted. At this point, the statistics are also updated in order to reflect the new page numbering. The process 400 then returns to block 402.

At block 410, the process 400 verifies if the administrator has selected to move a page. If so, at block 412, the page is move by selecting the new page position and, at block 414, the index 249 and XML table of content 250 files (see FIG. 4) are updated in order to reflect the change, i.e. pages are renumbered, links are adjusted. At this point, the statistics are also updated in order to reflect the new page numbering. The process 400 then returns to block 402.

At block 416, the process 400 verifies if the administrator has selected to replace a page. If so, at block 418, the administrator uploads the new page in PDF format and, at block 420, the automated conversion process 200 (see FIG. 3) is applied to the uploaded PDF page in order to produce a replacement page for the virtual publication. Following which, at block 422, the index 249 and XML table of content 250 files (see FIG. 4) are updated in order to reflect the change. The process 400 then returns to block 402.

At block 424, the process 400 verifies if the administrator has selected to add a hotspot. If so, at block 426, the administrator selects, on the page, an area, an image or a text string to be activated as a hotspot and, at block 428, the administrator adds a link to the hotspot, i.e. a URL, e-mail address, link to another page of the virtual publication or another virtual publication, etc. The information is then stored in the XML file 248 (see FIG. 4) corresponding to the modified page. The process 400 then returns to block 402.

At block 430, the process 400 verifies if the administrator has selected to add a video. If so, at block 418, the administrator selects, on the page, an area where the video is to be positioned and, at block 432, uploads or provides a link to the video. Following which, at block 434, the administrator may set parameters such as, for example, add a control bar or not, define a fade in/fade out, set loop playback, delete once played, etc. The information is then stored in the XML file 248 (see FIG. 4) corresponding to the modified page. The process 400 then returns to block 402.

At block 438, the process 400 verifies if the administrator has selected to edit a section. If so, at block 440, the administrator selects, in the second zone 60 of FIG. 7, a section 61 to be edited and, at block 442, sets the parameters of the section such as, for example, the section title 62 (i.e. Economy, Sport, World, etc.), the beginning page 63 and the ending page 64 of the section. Following which, at block 444, the index 249 and XML table of content 250 files (see FIG. 4) are updated in order to reflect the change, i.e. create a thumb index with the section title inscribed thereon, which will appear next to the virtual publication when displayed in the virtual publication application 322. Clicking the thumb index thus created in the virtual publication application 322 results in the virtual publication opening at the desired section. The process 400 then returns to block 402.

Finally, at block 446, the process 400 verifies if the administrator has selected to exit the virtual publication editor. If so, the process 400 exits, if not, it returns to block 402.

It is to be understood that other functionalities may be added. For example, the XML editable configuration file 251 (see FIG. 4) may be edited so as to for example, modify the appearance of the virtual publication. Furthermore, although beyond the addition of hotspots and video, other multimedia elements may be added such as, for example, audio, flash animation, etc.

It is to be further understood that any of the above described functionalities may be restricted to specific users or may be password protected, for example at block 110 of FIG. 2.

### Browsing the Virtual Publication

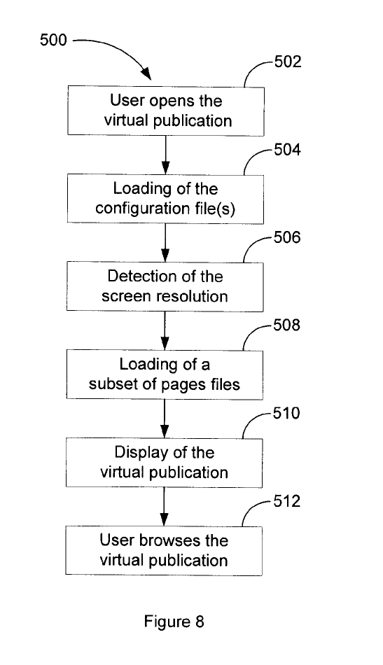

Referring to FIG. 8, there is shown a flow diagram of an illustrative example of a process 500 of a user opening a virtual publication for browsing. The steps of the process 500 are indicated by blocks 502 to 512.

The process 500 starts at block 502 where the user, using a personal computer 12, laptop computer 14 or personal assistant device 16, or any other such computing device, on which runs a user interface 10, accesses the virtual publication through the virtual publication application 322 of the access server 32 (see FIGS. 1 and 5).

At block 504, the configuration files, i.e. the index 249, XML table of content 250 and XML editable configuration 251 files (see FIG. 4) are loaded in order to identify the location, in the content repository 34 (see FIG. 5), of the text 242, SWF 244, image 246 and XML 248 files (see FIG. 4), associated with the pages of the virtual publication being accessed. It is to be understood that other configuration files may be loaded. For example, a configuration file associated with the virtual publication application 322, which contains display and/or functionality settings common to various virtual publications or associated with specific users (e.g. preferences set by users).

In an alternative embodiment, the content repository 34 (see FIG. 5) may be scanned to detect the presence of complimentary virtual publications in repository space(s) associated with the virtual publication to be displayed, for example inserts to be loaded along with the virtual publication and appearing as a thumb index, thumbnail or slider. These complimentary virtual publications may be identified, for example, using a specific nomenclature identifying them as inserts. This allows the inclusion of various inserts to be displayed only for specific periods of time without requiring any editing of the virtual publication.

At block 506, the screen resolution of the user interface 10 (see FIG. 5) is detected so that the image file 246 (see FIG. 4) may be displayed in a suitable resolution to the user in order to optimize the quality/weight ratio. Optionally, if required by the virtual publication application, the screen resolution can be used to select the image file 246 of the suitable resolution for loading.

Then, at block 508, a subset of the text 242, SWF 244, image 246 and XML 248 files (see FIG. 4) are loaded, for example the files corresponding to five pages before the current page and five pages after the current page, so as to reduce loading time. It is to be understood that a different number of pages or the whole virtual publication may be loaded at once or that pages may be loaded individually as the user browses the virtual publication. Optionally, if image files 246 of multiple resolutions are present for each page of the virtual publication, then only those corresponding to the screen resolution detected at block 506 are loaded.

At block 510, with reference to FIG. 9, the virtual publication application 322 displays the pages of the virtual publication on the user interface 10 (see FIG. 5) in the form of a virtual book 80, showing two pages 81, 82 in the fashion of an open book. It is to be understood that the virtual publication may also be displayed only one page at a time as per a normal web page. As previously mentioned, the displayed pages 81, 82 are the image versions of the pages, i.e. image files 246 (see FIG. 4). However, in order to allow search engines to index the virtual publication, the text version of the pages 81, 82, i.e. text files 242 (see FIG. 4), are hidden within the pages 81, 82. Finally, the hotspots or other links listed in the XML file 248 (see FIG. 4), if any, are activated within each page 81, 82.

It is to be understood that the virtual publication application 322 may be displayed on the user interface 10 contained within, for example, an HTML page which can include additional information such as, for example, advertisement or links to other web sites.

Finally, at block 512, the user may browse the virtual book 80, i.e. virtual publication, using a set of navigation, display, communication and search tools 83.

For example, the user may browse through the virtual book 80 by either entering the desire page, using the navigation tool 83 or turn the pages 81, 82 using his or her mouse as if he or she was turning the pages of a book.

The user may want to see details of a specific page 81, 82, in which case he or she may use the zoom tool 83 which will display the detailed SWF version, i.e. SWF file 244 (see FIG. 4), of the page 81, 82 being viewed. Alternatively, the SWF version may be previously loaded or may be loaded only when the zoom tool is used.

The user may also search through the virtual publication using the search tool 83, at which time the virtual publication application 322 queries the text files 242 (see FIG. 4) contained in the text repository 32 (see FIG. 5) associated with the displayed virtual publication in order to list the pages containing the desired term or expression. As previously described, thumbnails of the pages identified in the search result may be displayed to the user and may be linked to the actual pages.

A user may also search through the virtual publication using the highlighted search tool 83, in which case three parameters are returned:
the pages where the term or expression;
the context in which the term or expression may be found, for example 20 words before the desired term or expression and 20 words after; and
coordinates of the location of the term or expression within the page image.

The coordinates of the term or expression are extracted from the XML files 248 (see FIG. 4) and allow the virtual publication application 322 to create a highlight area, within the displayed pages 81, 82, in which the term or expression, along with the 20 preceding and following words, may be displayed.

Furthermore, the user may use other tools such as, for example, sending a link to the current page 81, 82 or virtual publication to a friend, create bookmarks, post notes, print pages 81, 82, etc.

As users access and browse the virtual publications, statistics are compiled by the virtual publication application 322 and are stored in the statistics repository 341 so to be accessible to the administrator of the virtual publication system 30, for example at block 136 of FIG. 2.

It is to be understood that although reference is made to the conversion of a PDF document into a virtual publication throughout this description, other formats of electronic documents such as, for example, WORD, may also be used along with the appropriate conversion software tools.

It is further to be understood that the PDF document may be converted into only the image and SWF formats, in which case the resulting virtual publication will allow the zoom functionality but not the search nor the clickable zone functionalities.

Although the present invention has been described by way of particular embodiments and examples thereof, it should be noted that it will be apparent to persons skilled in the art that modifications may be applied to the present particular embodiment without departing from the scope of the present invention.

What is claimed is:

1. A method for creating a virtual publication for use with a flip page application, comprising:
acquiring an electronic document;
converting each page of the electronic document into an image file to be displayed by the flip page application;
converting each page of the electronic document into a SWF file to be used by the flip page application to provide a zoom functionality; and
creating an index file listing of all image and SWF files composing the virtual publication for indicating to the flip page application which files to use.

2. A method according to claim 1, further comprising the step of converting each page of the electronic document into a text file to be associated with each image file by the flip page application in order to provide a search functionality.

3. A method according to claim 2, wherein the step of converting each page of the electronic document into a text file includes associating HTML tags to parts of the text according to font size.

4. A method according to any of claims 1 to 3, further comprising the step of converting each page of the electronic document into an XML file indicating coordinates and links of multimedia elements to be used by the flip page application to provide clickable zones.

5. A method according to any of claims 1 to 4, further comprising the step of creating a configuration file including appearance parameters of the virtual publication for use by the flip page application in displaying the virtual publication.

6. A method according to any of claims 1 to 5, further comprising the step of creating a table of content file including an index table of the virtual publication for use by the flip page application in navigating the virtual publication.

7. A method according to any of claims 1 to 6, wherein the image file is of the JPG format.

8. A method according to any of claims 1 to 7, wherein the electronic document is of a format selected from a group consisting of the PDF format and WORD format.

9. A virtual publication for use with a flip page application, comprising:
an image file of each page of the virtual publication to be displayed by the flip page application;
a SWF file of each page of the virtual publication to be used by the flip page application to provide a zoom functionality; and
an index file listing of all image and SWF files composing the virtual publication for indicating to the flip page application which files to use.

10. A virtual publication according to claim 9, further comprising a text file of each page of the virtual publication to be associated with each image file by the flip page application in order to provide a search functionality.

11. A virtual publication according to claim 10, wherein the text file includes HTML tags to parts of the text relating to font size.

12. A virtual publication according to any of claims 9 to 11, further comprising an XML file of each page of the virtual publication indicating coordinates and links of multimedia elements to be used by the flip page application to provide clickable zones.

13. A virtual publication according to any of claims 9 to 12, further comprising a configuration file including appearance parameters of the virtual publication for use by the flip page application in displaying the virtual publication.

14. A virtual publication according to any of claims 9 to 13 further comprising a table of content file including an index table of the virtual publication for use by the flip page application in navigating the virtual publication.

15. A virtual publication according to any of claims 9 to 14, wherein the image file is of the JPG format.

16. A virtual publication according to any of claims 9 to 15, wherein the electronic document is of a format selected from a group consisting of the PDF format and WORD format.

17. A system for creating a virtual publication for use with a flip page application, comprising:
an input for receiving an electronic document;
an image converter for converting each page of the electronic document into an image file to be displayed by the flip page application;
a SWF converter for converting each page of the electronic document into a SWF file to be used by the flip page application to provide a zoom functionality;
an indexer for creating an index file listing of all image and SWF files composing the virtual publication for indicating to the flip page application which files to use; and
a repository for storing the image and SWF files composing the virtual publication.

18. A system according to claim 17, further comprising a text converter for converting each page of the electronic document into a text file to be associated with each image file by the flip page application in order to provide a search functionality.

19. A system according to claim 18, wherein the text converter associates HTML tags to parts of the text according to font size.

20. A system according to any of claims 17 to 19, further comprising an XML converter for converting each page of the electronic document into an XML file indicating coordinates and links of multimedia elements to be used by the flip page application to provide clickable zones.

21. A system according to claim 20, wherein the XML converter further creates a configuration file including appearance parameters of the virtual publication for use by the flip page application in displaying the virtual publication.

22. A system according to either of claim 20 or 21, wherein the XML converter further creates a table of content file including an index table of the virtual publication for use by the flip page application in navigating the virtual publication.

23. A system according to any of claims 17 to 22, wherein the image file is of the JPG format.

24. A system according to any of claims 17 to 23, wherein the electronic document is of a format selected from a group consisting of the PDF format and WORD format.
